(19) United States
(12) Patent Application Publication
(10) Pub. No.: US 2026/0339187 A1
(43) Pub. Date: Oct. 29, 2026

(54) LIGHT-MIXING MODULE

(71) Applicant: QISDA CORPORATION, Taoyuan City (TW)

(72) Inventors: Kai-Jiun Wang, Taoyuan City (TW); Ching-Tze Huang, Taoyuan City (TW)

(73) Assignee: QISDA CORPORATION, Taoyuan City (TW)

(21) Appl. No.: 19/647,811

(22) Filed: Apr. 14, 2026

(30) Foreign Application Priority Data
Apr. 29, 2025 (CN) 202510553592.8

(51) Int. Cl. G03B 21/28; G03B 21/20

(52) U.S. Cl. CPC G03B 21/28; G03B 21/204

(57) ABSTRACT

A light-mixing module includes an exciting source, a condensing lens, a wavelength-conversion unit, and a light-mixing unit having reflective and dichroic surfaces. The reflective surface is obliquely opposite to the condensing lens. The dichroic surface is obliquely disposed between the reflective surface and the condensing lens for allowing a first color light of the exciting source to pass through. The reflective surface reflects the first color light from the condensing lens to pass through the dichroic surface and then be transmitted out of the light-mixing unit. The wavelength-conversion unit is disposed at a side of the condensing lens for partially reflecting the first color light to the reflective surface through the condensing lens and the dichroic surface and partially converting the first color light into a second color light, such that the second color light can be reflected by the dichroic surface to be mixed with the first color light.

### BACKGROUND OF THE INVENTION

### 1. Field of the Invention

The present invention relates to a light-mixing module, and more specifically, to a light-mixing module utilizing a dichroic surface and a reflective surface of a light-mixing unit to perform single-axis light mixing on a first color light of an exciting source and a second color light converted by a wavelength-conversion unit.

### 2. Description of the Prior Art

In general, a conventional laser projector adopt a light mixing design usually utilizing a blue laser light to excite phosphors to generate red and green lights, which form multicolor imaging lights together with the blue laser light for subsequent projection imaging. A common configuration thereof could be referred to FIG. 1, which is a diagram of a laser projection apparatus 10 in the prior art. As shown in FIG. 1, the laser projection apparatus 10 includes a laser source 12 and a light-mixing module 14, so that color lights emitted by the laser source 12 can be mixed through the light-mixing module 14 to provide multicolor imaging lights (e.g., red light, blue light, and green light) for the laser projection apparatus 10 to perform subsequent projection imaging.

Briefly, taking the laser source 12 being a blue laser source as an example, as shown in FIG. 1, the light-mixing module 14 includes a dichroic mirror 16, a phosphor wheel 18, and a plurality of reflective mirrors 20. When a blue light emitted by the laser source 12 enters the light-mixing module 14 and is incident onto the dichroic mirror 16, the dichroic mirror 16 allows the blue light to pass through and be incident onto the phosphor wheel 18. At this time, a phosphor layer on the phosphor wheel 18 is excited by the blue light to generate color lights different from the blue light (e.g., red light and green light) and reflects the color lights back to the dichroic mirror 16. In addition, a portion of the blue light passing through the phosphor wheel 18 is also sequentially reflected by the plurality of reflective mirrors 20 to be incident onto the dichroic mirror 16 again. In such a manner, after the blue light passes through the dichroic mirror 16 again via the reflection guidance of the plurality of reflective mirrors 20 and the aforesaid color lights different from the blue light are reflected by the dichroic mirror 16, the light-mixing module 14 can provide a plurality of imaging color lights to the laser projection apparatus 10 for subsequent projection imaging.

However, as shown in FIG. 1, the light-mixing module 14 must be configured with various optical components for light-mixing to form the imaging color lights. Therefore, the aforesaid design not only significantly increases the configuration cost of the optical components, but also increases the overall weight and volume of the laser projection apparatus, which is disadvantageous to the miniaturization design of the laser projection apparatus.

### SUMMARY OF THE INVENTION

The present invention provides a light-mixing module suitable for providing a mixed beam to a projection apparatus. The light-mixing module includes an exciting source, at least one first condensing lens, a light-mixing unit and a wavelength-conversion unit. The exciting source emits a first color light. The at least one first condensing lens has a first lens portion and a second lens portion. The light-mixing unit is disposed between the exciting source and the first condensing lens and has a reflective surface and a dichroic surface, wherein the reflective surface is obliquely disposed at a position opposite to the second lens portion, the dichroic surface is obliquely disposed between the reflective surface and the first condensing lens and faces the first lens portion and the second lens portion, the dichroic surface allows the first color light to pass through and be incident onto the first lens portion, and the reflective surface reflects the first color light transmitted from the second lens portion so that the first color light passes through the dichroic surface and is emitted from the light-mixing unit. The wavelength-conversion unit is disposed on another side of the first condensing lens opposite to the light-mixing unit, for partially reflecting the first color light to sequentially pass through the second lens portion and the dichroic surface and be incident onto the reflective surface, and for partially converting the first color light into at least one second color light to be reflected back to the dichroic surface, so that the at least one second color light is reflected by the dichroic surface and is mixed with the first color light reflected by the reflective surface to generate a mixed beam.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a laser projection apparatus in the prior art.

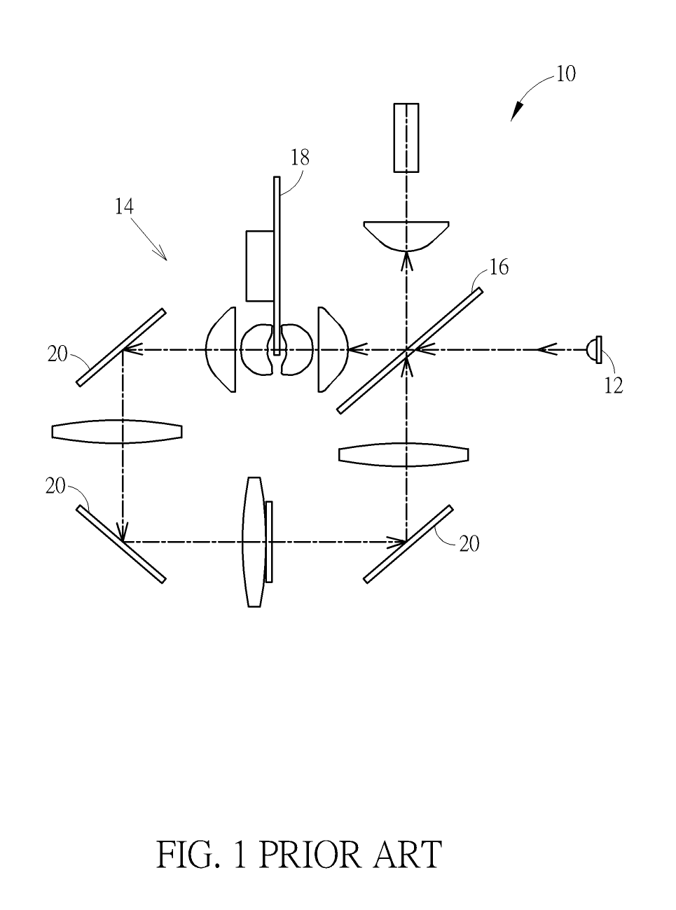

FIG. 2 is a diagram of a light-mixing module according to an embodiment of the present invention.

FIG. 3 is a diagram of a wavelength-conversion unit according to another embodiment of the present invention.

FIG. 4 is a diagram of a light-mixing module according to another embodiment of the present invention.

FIG. 5 is a diagram of a light-mixing module according to another embodiment of the present invention.

### DETAILED DESCRIPTION

The following content illustrates the technical content of the present invention with reference to specific embodiments and the accompanying drawings. Persons skilled in the art can easily understand other advantages and effects of the present invention from the contents disclosed in this specification. The present invention may also be implemented or applied through other different specific embodiments. Various details in this specification may also be modified and changed based on different viewpoints and applications without departing from the spirit of the present invention. In particular, the structural design and positional relationship of each component in the drawings (e.g., structural proportions and arrangement of each optical component in a light-mixing module and the related light path design) are for exemplary purposes only and do not represent the actual implementation status of the present invention.

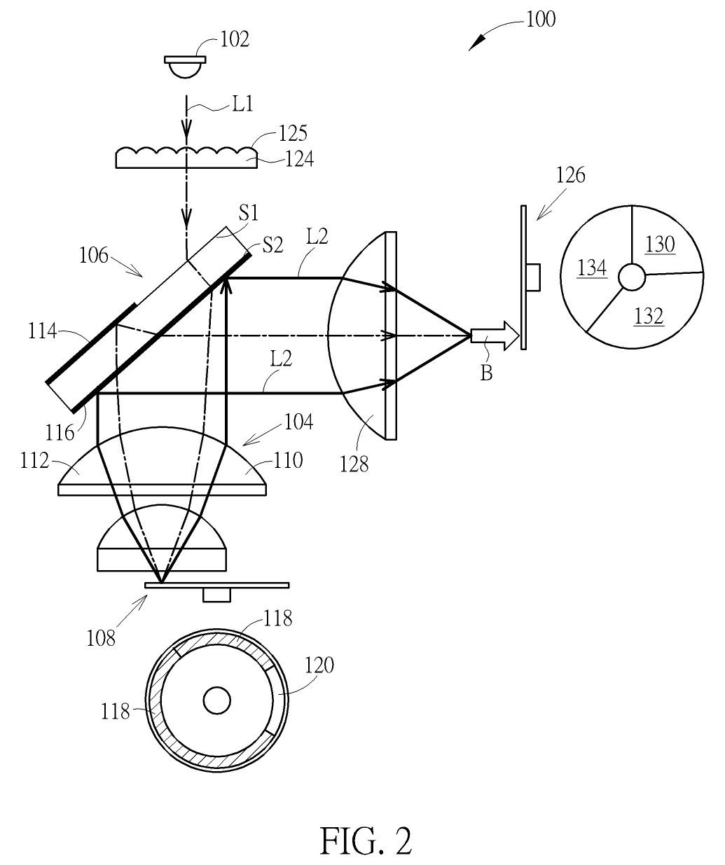

Please refer to FIG. 2, which is a diagram of a light-mixing module 100 according to an embodiment of the present invention. As shown in FIG. 2, the light-mixing module 100 is suitable for providing a mixed beam to a laser projection apparatus for subsequent projection imaging. The light-mixing module 100 includes an exciting source 102, at least one first condensing lens 104 (two shown in FIG. 2, but not limited thereto), a light-mixing unit 106, and a wavelength-conversion unit 108.

The exciting source 102 could preferably be a laser source for emitting a first color light L1 (e.g., blue light, but not limited thereto, meaning that the type of color light and the number of light source could be varied with the practical applications of the light-mixing module 100). The first condensing lens 104 could preferably be a collimator and has a first lens portion 110 and a second lens portion 112 for performing collimation and condensing on the first color light L1. The light-mixing unit 106 is disposed between the exciting source 102 and the first condensing lens 104 and has a reflective surface 114 and a dichroic surface 116. The reflective surface 114 is disposed obliquely at a position opposite to the second lens portion 112. The dichroic surface 116 is disposed obliquely between the reflective surface 114 and the first condensing lens 104 and faces the first lens portion 110 and the second lens portion 112. The dichroic surface 116 allows the first color light L1 to pass through and then be incident onto the first lens portion 110, and the reflective surface 114 reflects the first color light L1 transmitted from the second lens portion 112, so that the first color light L1 passes through the dichroic surface 116 and is emitted from the light-mixing unit 106. The wavelength-conversion unit 108 is disposed on another side of the first condensing lens 104 opposite to the light-mixing unit 106, for partially reflecting the first color light L1 transmitted from the first lens portion 110 to sequentially pass through the second lens portion 112 and the dichroic surface 116 and be incident onto the reflective surface 114, and for partially converting the first color light L1 into a second color light L2 to be reflected back to the dichroic surface 116, so that the second color light L2 is reflected by the dichroic surface 116. Accordingly, as shown in FIG. 2, the second color light L2 reflected by the dichroic surface 116 can be mixed with the first color light L1 reflected by the reflective surface 114 to generate a mixed beam B.

To be more specific, in this embodiment, the light-mixing unit 106 is a dichroic mirror and faces the exciting source 102 obliquely (the inclination angle of the dichroic mirror could preferably be equal to 45°, but not limited thereto). The reflective surface 114 is formed on a first surface S1 of the light-mixing unit 106 facing the exciting source 102, and the dichroic surface 116 is formed on a second surface S2 of the light-mixing unit 106 facing the first condensing lens 104. A thickness of the light-mixing unit 106 could preferably be between 9mm and 11mm, and a refractive index of the light-mixing unit 106 could preferably be between 1.4 and 1.6.

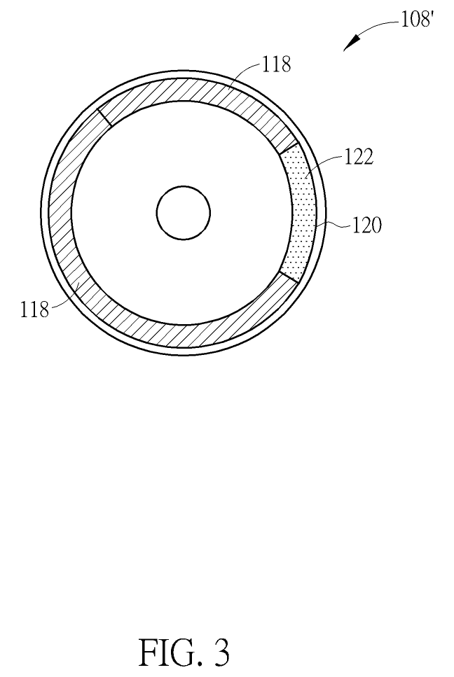

In addition, in this embodiment, the wavelength-conversion unit 108 could be a phosphor wheel. The wavelength-conversion unit 108 is rotatably disposed opposite to the light-mixing unit 106 and has at least one phosphor layer 118 (two shown in FIG. 2, but not limited thereto) and a reflective layer 120 (preferably formed by aluminum disk coating or by inlaying blue reflective glass, but not limited thereto) arranged sequentially around a periphery of the wavelength-conversion unit 108. In practical applications, the wavelength-conversion unit of the present invention could further adopt a diffusion structural design. For example, please refer to FIG. 3, which is a diagram of a wavelength-conversion unit 108’ according to another embodiment of the present invention. Components both mentioned in this embodiment and the aforesaid embodiments represent components with similar structures or functions, and the related description could be reasoned by analogy according to the aforesaid embodiments and omitted herein. As shown in FIG. 3, the wavelength-conversion unit 108’ could have a phosphor layer 118, a reflective layer 120, and a diffusion structure 122. The diffusion structure 122 could preferably be formed as an irregular structure on the reflective layer 120 by aluminum disk coating or by inlaying blue reflective glass, for diffusing the first color light L1 to further homogenize the energy and directivity of the first color light L1.

Furthermore, the light-mixing module 100 could also adopt a homogenizing design. For example, as shown in FIG. 2, the light-mixing module 100 could further include a homogenizing member 124. The homogenizing member 124 is disposed between the exciting source 102 and the light-mixing unit 106 to perform light homogenization on the first color light L1 emitted by the exciting source 102. The homogenizing member 124 could preferably be a fly-eye lens or other lens components with similar functions (but not limited thereto). In this embodiment, a lens array 125 could be formed on an optical surface of the homogenizing member 124 facing one of the exciting source 102 and the light-mixing unit 106. For example, as shown in FIG. 2, the lens array 125 is formed on the optical surface of the homogenizing member 124 facing the exciting source 102, but the present invention could be not limited thereto, meaning that the lens array 125 could be formed on the optical surface of the homogenizing member 124 facing the light-mixing unit 106 in another embodiment. In such a manner, compared with the prior art adopting a diffuser (which leads to uneven color-light energy) or double-sided fly-eye lens design (which causes an excessive manufacturing cost), the single-sided lens array design of the present invention not only ensures uniform color-light energy for improving the excitation efficiency of the phosphor layer, but also reduces the lens cost of the light-mixing module. As for the array structural design of the homogenizing member 124, the related description is omitted herein and not limited to FIG. 2 since it is commonly seen in the prior art and varied with the actual applications of the light-mixing module 100.

Via the aforesaid design, with rotation of the phosphor wheel, the first color light L1 passing through the dichroic surface 116 and the first lens portion 110 can be excited by the phosphor layer 118 to generate a wavelength conversion phenomenon when the first color light L1 is incident to the wavelength-conversion unit 108, and can be reflected by the reflective layer 120 to sequentially pass through the second lens portion 112 and the dichroic surface 116 and then be incident onto the reflective surface 114. For example, the exciting source 102 can emit the first color light L1 with blue light, and the phosphor layer 118 can correspondingly be a green phosphor layer and a yellow phosphor layer. Accordingly, the phosphor layer 118 can sequentially convert the first color light L1 into the second color light L2 with green light and yellow light, so that the second color light L2 can be mixed with the first color light L1 reflected by the reflective surface 114 into white light. Alternatively, the phosphor layer 118 could be a red-green phosphor layer, so that the phosphor layer 118 can sequentially convert the first color light L1 into the second color light L2 with red light and green light, so that the second color light L2 can be mixed with the first color light L1 reflected by the reflective surface 114 into white light. However, the present invention is not limited thereto, meaning that the types of color lights and phosphor layers may vary according to the actual light mixing requirements of the light-mixing module 100. In addition, in order to improve the reflection efficiency of the first color light L1 on the reflective layer 120, a reflective surface of the reflective layer 120 on the phosphor wheel could preferably be level with or higher than a phosphor surface of the phosphor layer 118. For example, a height difference between the reflective surface of the reflective layer 120 and the phosphor surface of the phosphor layer 118 could be between 0 and 0.2 mm (but not limited thereto, meaning that the surface height design may vary according to the actual mixed light uniformity of the light-mixing module 100).

Via the aforementioned light guiding design, the light-mixing unit 106 can guide the first color light L1 to pass through the dichroic surface 116 and be sequentially reflected by the wavelength-conversion unit 108 and the reflective surface 114 to perform single-axis light mixing with the second color light L2 converted by the wavelength-conversion unit 108, so as to generate the mixed beam B for providing a plurality of imaging color lights to the laser projection apparatus for subsequent projection imaging.

To be noted, as shown in FIG. 2, the light-mixing module 100 could further include a color wheel 126 and a second condensing lens 128. The color wheel 126 is used to receive the mixed beam B to generate a plurality of projection color lights. The second condensing lens 128 could preferably be a collimator (but not limited thereto) and is disposed between the color wheel 126 and the light-mixing unit 106 for focusing the mixed beam B to be incident onto the color wheel 126. More specifically, in this embodiment, the color wheel 126 could have a red filter block 130, a green filter block 132, and a blue filter block 134 arranged radially to filter the mixed beam B to generate the projection color lights (i.e., red light, green light, blue light) for the laser projection apparatus to perform subsequent projection imaging.

In summary, compared with the light-mixing module of the prior art which must be configured with various optical components for light-mixing to form multicolor imaging lights, the present invention only utilizes a simple configuration of the light-mixing unit (with the aforesaid light guiding design) and the wavelength-conversion unit (with the aforesaid light conversion/reflection design) to provide a mixed beam with multicolor light distributed in proper proportions. In such a manner, the present invention not only significantly reduces the configuration cost of the optical components in the laser projection apparatus, but also effectively reduces the overall weight and volume of the laser projection apparatus, which is advantageous to the miniaturization design of the laser projection apparatus. Furthermore, via the aforementioned design of appropriately controlling the structural thickness of the light-mixing unit to extend an optical travelling distance of the first color light, the present invention not only can reliably guide the first color light emitted by the exciting source and the second color light excited by the wavelength-conversion unit to perform coaxial light-mixing, so as to reduce the number of optical components configured in the light-mixing module, reduce assembly tolerances, and improve the image projection quality and color uniformity of the laser projection apparatus, but also can avoid the problem of uneven color of the projected image caused by the first color light being incident onto the first condensing lens at a large angle, leading to uneven color-light energy of the first color light mismatching with the color-light energy of the second color light excited by the wavelength-conversion unit.

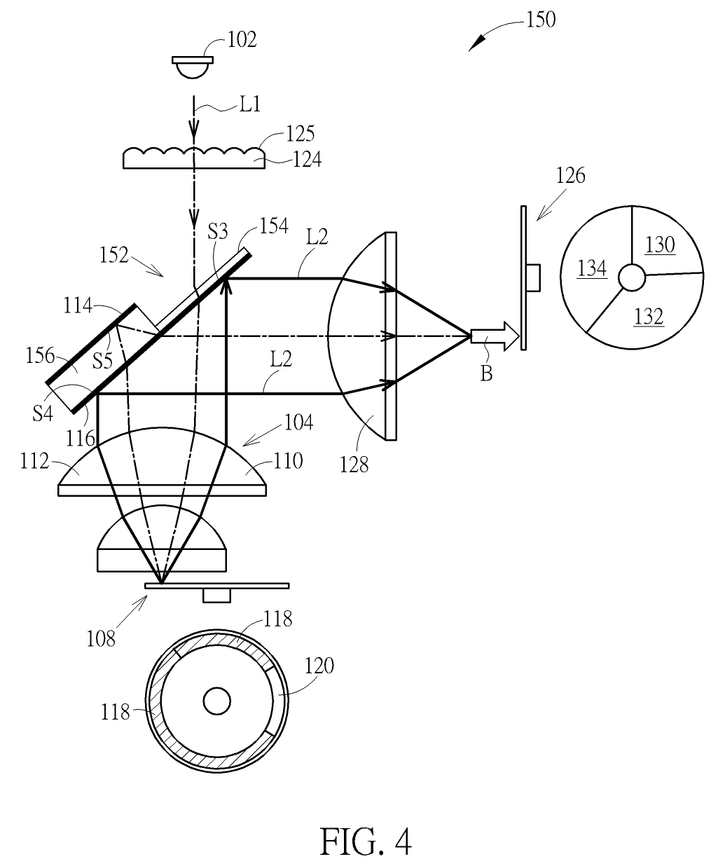

It should be mentioned that the light-mixing unit of the present invention could also adopt a non-uniform thickness dichroic mirror design. For example, please refer to FIG. 4, which is a diagram of a light-mixing module 150 according to another embodiment of the present invention. Components both mentioned in this embodiment and the aforesaid embodiments represent components with similar structures or functions, and the related description could be reasoned by analogy according to the aforesaid embodiments and omitted herein. As shown in FIG. 4, the light-mixing module 150 includes a light-mixing unit 152, the exciting source 102, the first condensing lens 104, the wavelength-conversion unit 108, the homogenizing member 124, the color wheel 126, and the second condensing lens 128. In this embodiment, the light-mixing unit 152 could include a first dichroic mirror 154 and a second dichroic mirror 156. The first dichroic mirror 154 is obliquely disposed between the exciting source 102 and the first lens portion 110 (the inclination angle of the first dichroic mirror 154 could preferably be equal to 45°, but not limited thereto). The second dichroic mirror 156 is connected to one side of the first dichroic mirror 154 and faces the second lens portion 112 obliquely (the inclination angle of the second dichroic mirror 156 could preferably be equal to 45°, but not limited thereto). The dichroic surface 116 is formed on a first surface S3 of the first dichroic mirror 154 facing the first lens portion 110 and formed on a second surface S4 of the second dichroic mirror 156 facing the second lens portion 112. The reflective surface 114 is formed on a third surface S5 of the second dichroic mirror 156. The second surface S4 and the third surface S5 are opposite to each other, and a thickness of the first dichroic mirror 154 is smaller than a thickness of the second dichroic mirror 156, wherein the thickness of the second dichroic mirror 156 could preferably be between 9mm and 11mm, and refractive indices of the first dichroic mirror 154 and the second dichroic mirror 156 could preferably be between 1.4 and 1.6.

Via the above design, with rotation of the phosphor wheel, the first color light L1 passing through the dichroic surface 116 of the first dichroic mirror 154 and the first lens portion 110 can be excited by the phosphor layer 118 to generate a wavelength conversion phenomenon when the first color light L1 is incident onto the wavelength-conversion unit 108, and can be reflected by the reflective layer 120 to sequentially pass through the second lens portion 112 and the dichroic surface 116 of the second dichroic mirror 156 and then be incident onto the reflective surface 114 of the second dichroic mirror 156. In such a manner, via the aforementioned light guiding design, the light-mixing unit 152 can guide the first color light L1 to pass through the dichroic surface 116 and be sequentially reflected by the wavelength-conversion unit 108 and the reflective surface 114, thereby performing single-axis light-mixing with the second color light L2 converted by the wavelength-conversion unit 108 to generate the mixed beam B, so as to provide a plurality of imaging color lights required for subsequent projection imaging to the laser projection apparatus.

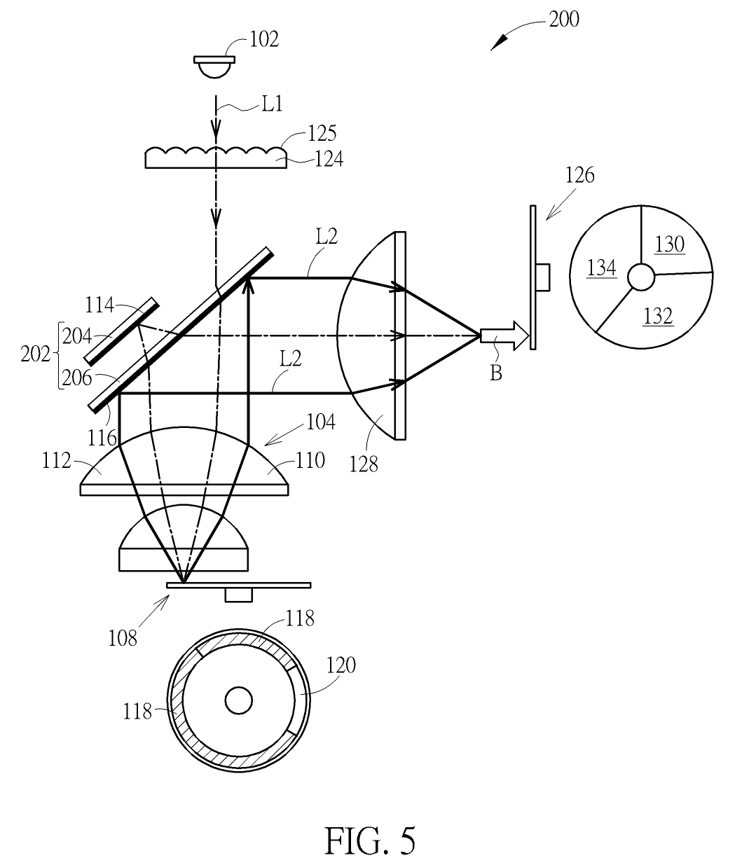

Moreover, the light-mixing unit of the present invention could also adopt a design in which the dichroic mirror and the reflective mirror are spaced apart from each other. For example, please refer to FIG. 5, which is a diagram of a light-mixing module 200 according to another embodiment of the present invention. Components both mentioned in this embodiment and the aforesaid embodiments represent components with similar structures or functions, and the related description could be reasoned by analogy according to the aforesaid embodiments and omitted herein. As shown in FIG. 5, the light-mixing module 200 includes a light-mixing unit 202, the exciting source 102, the first condensing lens 104, the wavelength-conversion unit 108, the homogenizing member 124, the color wheel 126, and the second condensing lens 128. In this embodiment, the light-mixing unit 202 could include a reflective mirror 204 and a dichroic mirror 206. The reflective mirror 204 faces the second lens portion 112 obliquely (the inclination angle of the reflective mirror 204 could preferably be equal to 45°, but not limited thereto). The dichroic mirror 206 is obliquely disposed between the reflective mirror 204 and the first condensing lens 104 (the inclination angle of the dichroic mirror 206 could preferably be equal to 45°, but not limited thereto) and is spaced apart from the reflective mirror 204. The dichroic surface 116 is formed on a surface of the dichroic mirror 206 facing the first condensing lens 104, and the reflective surface 114 is formed on a surface of the reflective mirror 204 facing the dichroic mirror 206.

Via the above design, with rotation of the phosphor wheel, the first color light L1 passing through the dichroic surface 116 of the dichroic mirror 204 and the first lens portion 110 can be excited by the phosphor layer 118 to generate a wavelength conversion phenomenon when the first color light L1 is incident onto the wavelength-conversion unit 108, and can be reflected by the reflective layer 120 to sequentially pass through the second lens portion 112 and the dichroic surface 116 of the dichroic mirror 206 and then be incident onto the reflective surface 114 of the reflective mirror 204. In such a manner, via the aforementioned light guiding design and by properly controlling a structural thickness of the dichroic mirror 206 and an air spacing distance between the dichroic mirror 206 and the reflective mirror 204, the light-mixing unit 202 can guide the first color light L1 to pass through the dichroic surface 116 and be sequentially reflected by the wavelength-conversion unit 108 and the reflective surface 114, thereby performing single-axis light-mixing with the second color light L2 converted by the wavelength-conversion unit 108 to generate the mixed beam B, so as to provide a plurality of imaging color lights required for subsequent projection imaging to the laser projection apparatus.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A light-mixing module suitable for providing a mixed beam to a projection apparatus, the light-mixing module comprising:
an exciting source emitting a first color light;
at least one first condensing lens having a first lens portion and a second lens portion;
a light-mixing unit disposed between the exciting source and the first condensing lens and having a reflective surface and a dichroic surface, wherein the reflective surface is obliquely disposed at a position opposite to the second lens portion, the dichroic surface is obliquely disposed between the reflective surface and the first condensing lens and faces the first lens portion and the second lens portion, the dichroic surface allows the first color light to pass through and be incident onto the first lens portion, and the reflective surface reflects the first color light transmitted from the second lens portion so that the first color light passes through the dichroic surface and is emitted from the light-mixing unit; and
a wavelength-conversion unit disposed on another side of the first condensing lens opposite to the light-mixing unit, for partially reflecting the first color light to sequentially pass through the second lens portion and the dichroic surface and be incident onto the reflective surface, and for partially converting the first color light into at least one second color light to be reflected back to the dichroic surface, so that the at least one second color light is reflected by the dichroic surface and is mixed with the first color light reflected by the reflective surface to generate a mixed beam.

2. The light-mixing module of claim 1, wherein the light-mixing unit is a dichroic mirror, the reflective surface is formed on a first surface of the dichroic mirror facing the exciting source, and the dichroic surface is formed on a second surface of the dichroic mirror facing the first condensing lens.

3. The light-mixing module of claim 2, wherein a thickness of the dichroic mirror is between 9mm and 11mm, and a refractive index of the dichroic mirror is between 1.4 and 1.6.

4. The light-mixing module of claim 1, wherein the light-mixing unit comprises a first dichroic mirror and a second dichroic mirror, the first dichroic mirror is obliquely disposed between the exciting source and the first lens portion, the second dichroic mirror is connected to one side of the first dichroic mirror and faces the second lens portion obliquely, the dichroic surface is formed on a first surface of the first dichroic mirror facing the first lens portion and formed on a second surface of the second dichroic mirror facing the second lens portion, the reflective surface is formed on a third surface of the second dichroic mirror, the second surface and the third surface are opposite to each other, and a thickness of the first dichroic mirror is smaller than a thickness of the second dichroic mirror.

5. The light-mixing module of claim 4, wherein the thickness of the second dichroic mirror is between 9 mm and 11 mm.

6. The light-mixing module of claim 4, wherein refractive indexes of the first dichroic mirror and the second dichroic mirror are between 1.4 and 1.6.

7. The light-mixing module of claim 1, wherein the light-mixing unit comprises a reflective mirror and a dichroic mirror, the reflective mirror faces the second lens portion obliquely, the dichroic mirror is obliquely disposed between the reflective mirror and the first condensing lens, the dichroic surface is formed on a surface of the dichroic mirror facing the first condensing lens, and the reflective surface is formed on a surface of the reflective mirror facing the dichroic mirror.

8. The light-mixing module of claim 1, wherein the wavelength-conversion unit is a phosphor wheel, the phosphor wheel is rotatably disposed on the another side and has at least one phosphor layer and a reflective layer arranged sequentially around a periphery of the phosphor wheel, the at least one phosphor layer converts the first color light into the at least one second color light, and the reflective layer reflects the first color light to the second lens portion.

9. The light-mixing module of claim 8, wherein a reflective surface of the reflective layer on the phosphor wheel is level with or higher than a phosphor surface of the phosphor layer, and a height difference between the reflective surface of the reflective layer and the phosphor surface of the phosphor layer is between 0 and 0.2mm.

10. The light-mixing module of claim 8, wherein the at least one first condensing lens is a collimator, the exciting source is a laser source, the first color light is blue light, and the at least one phosphor layer comprises a green phosphor layer and a yellow phosphor layer.

11. The light-mixing module of claim 8, wherein the phosphor wheel further has a diffusion structure, and the diffusion structure is formed on the reflective layer to diffuse the first color light.

12. The light-mixing module of claim 11, wherein the reflective layer is formed by aluminum disk coating or by inlaying blue reflective glass, and the diffusion structure is formed by generating an irregular structure on an aluminum disk or by inlaying a diffusion glass sheet.

13. The light-mixing module of claim 1 further comprising:
a homogenizing member disposed between the exciting source and the light-mixing unit, for receiving the first color light to perform light homogenization.

14. The light-mixing module of claim 13, wherein a lens array is formed on an optical surface of the homogenizing member facing one of the exciting source and the light-mixing unit.

15. The light-mixing module of claim 1 further comprising:
a color wheel receiving the mixed beam to generate a plurality of projection color lights; and
a second condensing lens disposed between the color wheel and the light-mixing unit, for focusing the mixed beam to be incident onto the color wheel.

16. The light-mixing module of claim 15, wherein the color wheel has a red filter block, a green filter block, and a blue filter block arranged radially.

17. The light-mixing module of claim 1, wherein the light-mixing unit is a dichroic mirror, the wavelength-conversion unit is a phosphor wheel, and the light-mixing module further comprises a homogenizing member, a color wheel, and a second condensing lens; the reflective surface is formed on a first surface of the dichroic mirror facing the exciting source, and the dichroic surface is formed on a second surface of the dichroic mirror facing the first condensing lens, wherein a thickness of the dichroic mirror is between 9mm and 11mm, and a refractive index of the dichroic mirror is between 1.4 and 1.6; the phosphor wheel is rotatably disposed on the another side and has at least one phosphor layer and a reflective layer arranged sequentially around a periphery of the phosphor wheel, the at least one phosphor layer converts the first color light into the at least one second color light, and the reflective layer reflects the first color light to the second lens portion; the homogenizing member is disposed between the exciting source and the light-mixing unit, and a lens array is formed on an optical surface of the homogenizing member facing one of the exciting source and the light-mixing unit to perform light homogenization on the first color light; the color wheel receives the mixed beam to generate a plurality of projection color lights, and the second condensing lens is disposed between the color wheel and the light-mixing unit to focus the mixed beam to be incident onto the color wheel.

18. The light-mixing module of claim 1, wherein the light-mixing unit comprises a first dichroic mirror and a second dichroic mirror, the wavelength-conversion unit is a phosphor wheel, and the light-mixing module further comprises a homogenizing member, a color wheel, and a second condensing lens; the first dichroic mirror is obliquely disposed between the exciting source and the first lens portion, the second dichroic mirror is connected to one side of the first dichroic mirror and faces the second lens portion obliquely, the dichroic surface is formed on a first surface of the first dichroic mirror facing the first lens portion and formed on a second surface of the second dichroic mirror facing the second lens portion, the reflective surface is formed on a third surface of the second dichroic mirror, the second surface and the third surface are opposite to each other, and a thickness of the first dichroic mirror is smaller than a thickness of the second dichroic mirror, wherein the thickness of the second dichroic mirror is between 9mm and 11mm, and refractive indexes of the first dichroic mirror and the second dichroic mirror are between 1.4 and 1.6; the phosphor wheel is rotatably disposed on the another side and has at least one phosphor layer and a reflective layer arranged sequentially around a periphery of the phosphor wheel, the at least one phosphor layer converts the first color light into the at least one second color light, and the reflective layer reflects the first color light to the second lens portion; the homogenizing member is disposed between the exciting source and the light-mixing unit, and a lens array is formed on an optical surface of the homogenizing member facing one of the exciting source and the light-mixing unit to perform light homogenization on the first color light; the color wheel receives the mixed beam to generate a plurality of projection color lights, and the second condensing lens is disposed between the color wheel and the light-mixing unit to focus the mixed beam to be incident onto the color wheel.

19. The light-mixing module of claim 1, wherein the light-mixing unit comprises a reflective mirror and a dichroic mirror, the wavelength-conversion unit is a phosphor wheel, and the light-mixing module further comprises a homogenizing member, a color wheel, and a second condensing lens; the reflective mirror faces the second lens portion obliquely, the dichroic mirror is obliquely disposed between the reflective mirror and the first condensing lens, the dichroic surface is formed on a surface of the dichroic mirror facing the first condensing lens, and the reflective surface is formed on a surface of the reflective mirror facing the dichroic mirror; the phosphor wheel is rotatably disposed on the another side and has at least one phosphor layer and a reflective layer arranged sequentially around a periphery of the phosphor wheel, the at least one phosphor layer converts the first color light into the at least one second color light, and the reflective layer reflects the first color light to the second lens portion; the homogenizing member is disposed between the exciting source and the light-mixing unit, and a lens array is formed on an optical surface of the homogenizing member facing one of the exciting source and the light-mixing unit to perform light homogenization on the first color light; the color wheel receives the mixed beam to generate a plurality of projection color lights, and the second condensing lens is disposed between the color wheel and the light-mixing unit to focus the mixed beam to be incident onto the color wheel.

20. The light-mixing module of claim 18, wherein the at least one first condensing lens and the second condensing lens are collimators, the exciting source is a laser source, and the first color light is blue light.
